(19) United States
(12) Patent Application Publication
(10) Pub. No.: US 2014/0258259 A1
(43) Pub. Date: Sep. 11, 2014

(54) LIBRARY RESOURCE AVAILABILITY IN SEARCH ENGINE RESULTS

(71) Applicant: SIRSI CORPORATION, Lehi, UT (US)

(72) Inventor: Talin Ryan Bingham, Wanship, UT (US)

(73) Assignee: SIRSI Corporation, Lehi, UT (US)

(21) Appl. No.: 13/790,331

(22) Filed: Mar. 8, 2013

(51) Int. Cl. G06F 17/30

(52) U.S. Cl. CPC G06F 17/30864
USPC 707/707; 707/706

(57) ABSTRACT

Providing real time information on the availability of physical published works at a library available for check-out by patrons of the library. The method includes at a search engine service, receiving a search request from a user. The search request includes terms related to a published work. The method further includes receiving information from a library having a branch which patrons can physically visit and check out published works. The information includes information about the real time availability of the published work at the library. The method further includes identifying conventional Internet search results for the terms related to the published work. The method further includes providing to the user, in a common interface, conventional Internet search results together with the real time availability of the published work at the library branch where patrons can physically visit and check out the published work.

### BACKGROUND

### Background and Relevant Art

Computers and computing systems have affected nearly every aspect of modern living. Computers are generally involved in work, recreation, healthcare, transportation, entertainment, household management, etc.

Further, computing system functionality can be enhanced by a computing systems ability to be interconnected to other computing systems via network connections. The connections allow a computing system to access services at other computing systems and to quickly and efficiently receive application data from other computing system.

Interconnectivity allows for users to access large amounts of data in large networks. For example, by accessing the Internet, a user can access a virtually unlimited amount of data. A single user would never be able to realistically search information on the Internet without some form of indexing of the Internet. Thus, search engines facilitate a user finding information on the Internet.

Users can also use the internet to purchase goods and services from on-line retailers. For example, a user who wishes to purchase a book may be able to perform an Internet search using a search engine. The search engine may identify on-line retailers that can supply the book, such as Amazon.com or other retailers. However, a user may have need for more immediate access to the goods.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method for providing real time information on the availability of physical published works at a library available for check-out by patrons of the library. The method includes at a search engine service, receiving a search request from a user. The search request includes terms related to a published work. The method further includes receiving information from a library having a branch which patrons can physically visit and check out published works. The information includes information about the real time availability of the published work at the library. The method further includes identifying conventional Internet search results for the terms related to the published work. The method further includes providing to the user, in a common interface, conventional Internet search results together with the real time availability of the published work at the library branch where patrons can physically visit and check out the published work.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1A illustrates a view of an interface allowing a user to enter search terms;

FIG. 1B illustrates a view of a search result page;

FIG. 1C illustrates another view of a search result page;

FIG. 1D illustrates a different view of the search result page of FIG. 1C;

FIG. 1E illustrates a different view of the search result page of FIG. 1C;

FIG. 1F illustrates a different view of the search result page of FIG. 1C;

FIG. 2 illustrates a system view of various systems that may interact to provide real time information about the availability of published works and products to a user; and

FIG. 3 illustrates a method of providing real time information on the availability of physical published works at a library available for check-out by patrons of the library.

### DETAILED DESCRIPTION

The present invention provides for an extension of modern search engines to provide results directed to availability of products in locations other than on-line retailers. For example, a user may search for the book “Treasure Island”. The user would receive results that included links to general information about the book “Treasure Island”, links to pages of on-line retailers, such as Amazon.com that allowed the user to buy the book, and also search results indicating that the book is available at their local library and the status of the book at the local library (e.g. checked-in, on hold, checked-out, etc.). A link to the local libraries catalog could additionally or alternatively be included in the search result. Embodiments may also include links to local brick and mortar retailers where a user could go and physically buy the book.

In an alternative example, a search for “size 12 gym shoes” may return, among other ordinary search engine results, including some for on-line retailers selling gym shoes, results for stores local to the user and a listing of a quantity gym shoes in size 12 available at the local stores along with a link to the local store.

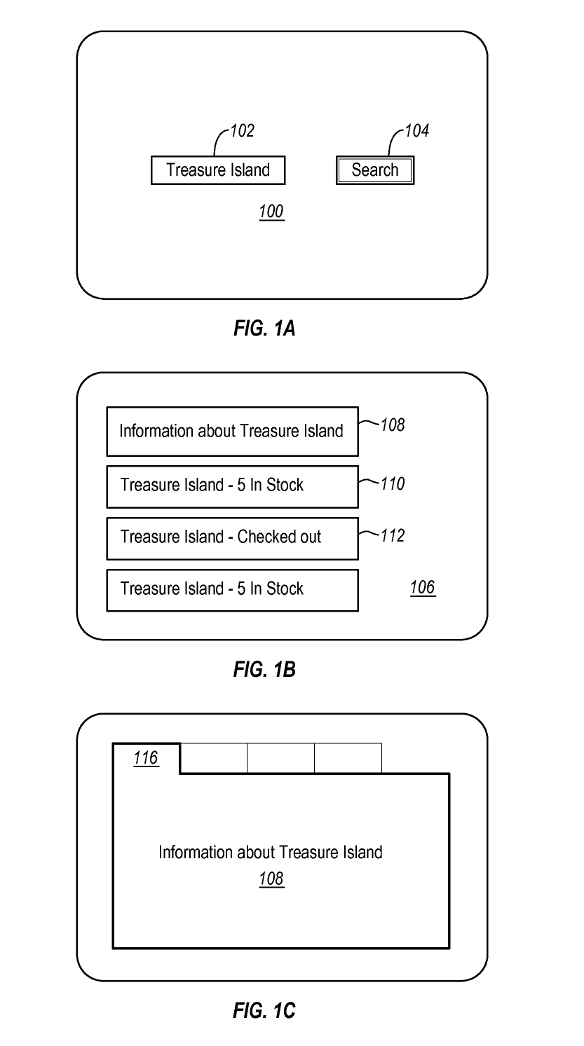

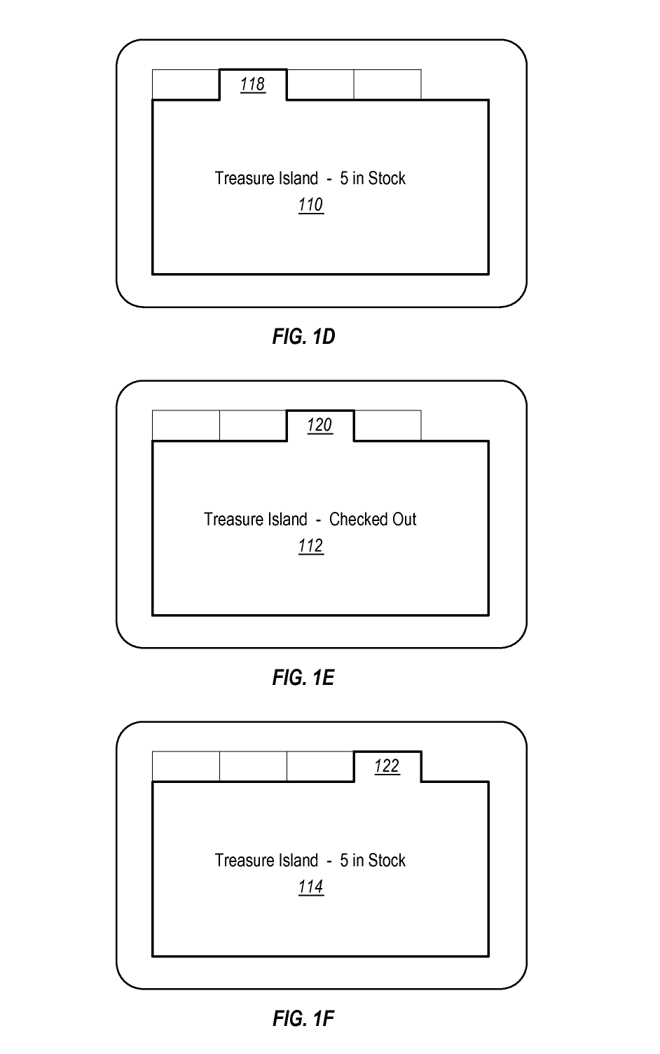

Referring now to FIG. 1A, a view 100 of a user interface is illustrated. The view 100 includes a text input box 102 and a search button 104. A user types search terms into the text input box 102 and pushes the search button 104 to cause a search to be performed.

FIG. 1B illustrates a view 106 of four different types of search results that may be returned. In particular, FIG. 1B illustrates that the search returns general search results 108 that a user might expect from a conventional search engine. This may include links to various Internet sites and web pages with further information regarding the searched for terms entered into the text input box 102.

In addition, the search returns results 110 for on-line retailers from which a user might purchase goods or services related to the searched for terms entered into the text input box 102. For example, such results 110 might specifically indicate on-line retailers who have the goods available, pricing for the goods, quantity of the goods available, etc. The results 110 may alternatively or additionally include links to the on-line retailer sources where a user can access an on-line retailer's web site, and in particular the on-line retailer's web page for a particular good, such that the user can purchase the good from the on-line retailer and have the good shipped to them.

In addition, the search returns results 112 related to a physical library branch where a user could check out physical copies of creative works related to the search terms entered into the text input box 102. For example, the search results 112 may include an indication of a specific physical branch of a library, a specific creative work, and the status of the specific creative work.

For example, a specific result in the results 112 may identify a library by name and/or physical location. The specific result may also identify a specific creative work, such as paperback or hardback book, a compact disk, a DVD, or other work available at a library branch. The result may indicate whether the work is checked in, checked out, on hold for another patron, etc. The result may also indicate the shelf location of the work, including in some embodiments, providing a map to the location of the work.

The result may further include a selectable link allowing a user to navigate a web browser to an interface for the integrated library system (ILS) of the library (or library branch). This can allow the user to reserve the work using their account with the library. In some embodiments, the search engine results 112 may include additional functionality that allows the user to reserve the work directly from the search engine results page without needing to navigate in the browser directly to the ILS of the library or library branch. In particular, as illustrated below, a search engine service may be able to communicate directly with an ILS of a library such that the search engine can obtain real time information about works available at a physical library and interact with the ILS to reserve works or perform other functionality.

FIG. 1B further illustrates that the search further returns results 114 which may provide information about a brick and mortar store where a user can physically visit to purchase items related to terms entered into the text input box 102. The results 114 may include more than simply a location where goods can be physically purchased in that the results 114 may provide real time stock and availability information. For example, the search results 114 may indicate the location of a brick and mortar store, the name of the store, price of the items at the store and the number of a particular item in stock at the brick and mortar store. A particular result in the results 114 may also include a link which allows a user to navigate a web page directly to the brick and mortar stores website (and optionally product page) which allows the user to obtain directions, contact information, store hours, request that an item be held for later pick-up, etc.

While FIG. 1B illustrates that different types of results (i.e. results 108, 110, 112 and 114) can be presented such that a user can view different types of results simultaneously, other embodiments may present the results together in a search engine interface, but in a fashion where users can select the type of results that they want to view at any given time. This is illustrated in FIGS. 1C through 1F. In particular, FIG. 1C illustrates that the results 108 can be viewed by selecting a tab 116. FIG. 1D illustrates that the results 110 can be viewed by selecting a tab 118. FIG. 1E illustrates that results 112 can be viewed by selecting a tab 120, and FIG. 1F illustrates that results 114 can be viewed by selecting a tab 122.

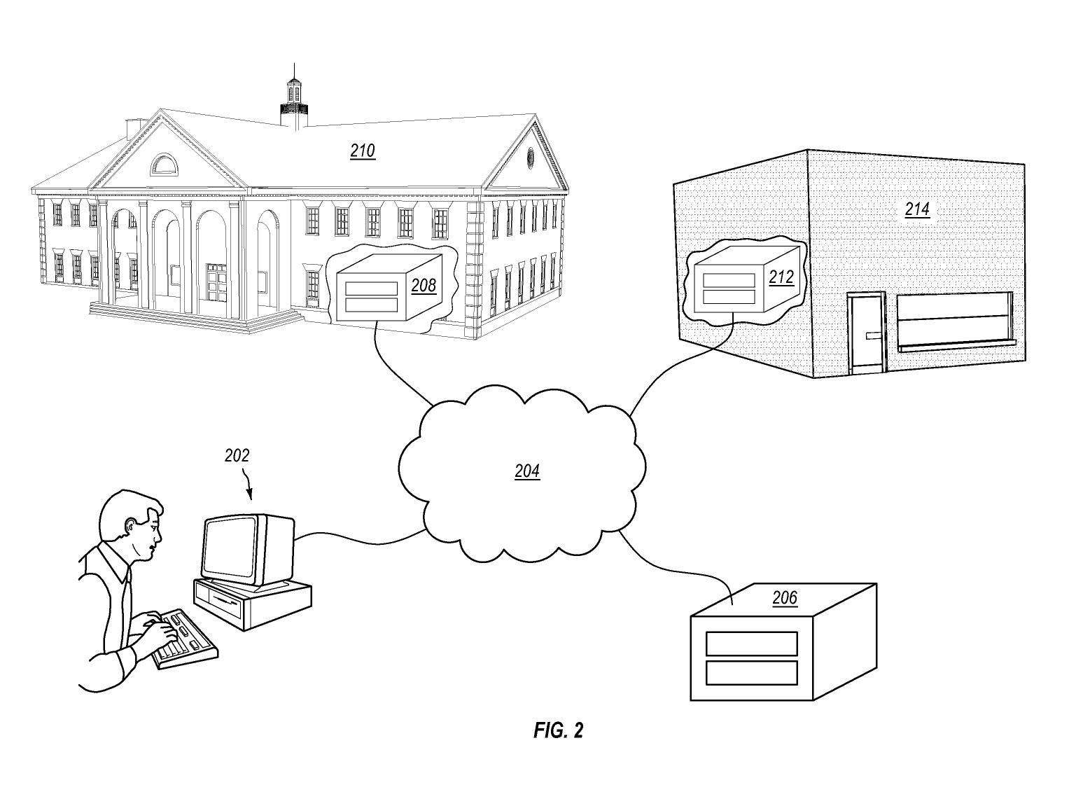

Referring now to FIG. 2, details are illustrated regarding interconnection of computing systems. FIG. 2 illustrates a client system 202 connected to the Internet 204. A user may use the client system 202 to access various resources available on the Internet. FIG. 2 further illustrates a search engine service 206 connected to the Internet 204. The client system 202 can connect to the search engine service 206 through the Internet 204. In this fashion, a user, at the client system 202, can submit search terms to the search engine service 206.

The search engine service can provide results, such as results 108, 110, 112 and 114 illustrated above, through the Internet 204 to the user at the client system 202. The search engine service 206 can obtain the results in a number of different ways. For example, to obtain general search results 108, the search engine service 206 can use various indexing techniques to index web sites and web pages available on the Internet. To obtain results 110 for on-line retailers, the search engine service 206 may again use traditional indexing techniques. Additionally, the search engine service 206 may have advertising agreements with on-line retailers to provide results with links to on-line retailers when certain search terms are searched.

To obtain results 112 for a physical library branch, the search engine service 206 may connect to an ILS 208 of a library 210 through the Internet 204. This can be done in a number of different fashions. In one example, the ILS 208 of the library 210 may provide update files to the search engine service 206 indicating the status of all or a portion of selected works available at the library. Alternatively, the search engine service 206 may be able to query the ILS 208 of the library 210 at the time that a user submits a search to the search engine.

It should be appreciated that there may be a number of different libraries or library branches that a user may be interested in obtaining published works from. Thus, embodiments may be limited to providing results from only those libraries which the user has an interest. This may be accomplished in a number of different ways. For example, the search engine service 206 may have functionality for determining the approximate (or in some cases, exact) location of a user. For example, the search engine service 206 may be able to determine what Internet service provider (ISP) a user is connected to and what geographical locations that ISP services. Alternatively, if the user is using a mobile device as the client system 202, the mobile device may include GPS, AGPS, cell tower tracking, or other functionalities for determining the location of the client system 202. This information can be provided to the search engine service 206. The search engine service 206 may then be able to query library ILSs that are within some distance (such as for example, either by time or by geography) from the user.

Alternatively, a user may be able to configure settings with the search engine service 206. Such settings may indicate specific libraries or locations that the user is interested in. These setting could be saved by the search engine service 206 so that anytime the user performed a search, these settings would be used. Thus, the search engine service 206 would only need to query library ILSs that are known to be of interest to the user.

In yet another alternative example, the user may have linked accounts between the library ILS 208 and the search engine service 206. By the search engine service 206 knowing what ILS accounts a user has, the search engine service can search those accounts when search requests are made by a user at the client system 202.

To obtain results 114 for a brick and mortar store, the search engine service 206 may be able to connect to an inventory server 212 for the brick and mortar store 214. The inventory server 212 may have real time information about products available at the brick and mortar store 214. As items are purchased at the brick and mortar store, or as merchandise is received at the brick and mortar store 214, the inventory server 212 may be updated to reflect this information. The inventory server 212 may be connected to the internet 204 such that such information can be provided to the search engine service 206. In particular, the search engine service 206 may be able to query the inventory server 212 in conjunction with preparing results from a query submitted by a user at a client device 202.

Selection of brick and mortar stores to have results included may be done in a number of different ways. For example, In some embodiments, Results may be included by virtue of a store purchasing rights to have their results be included. Further, results may be location based as described above in the library example. In particular, results that are relevant to a user based on the physical location of the user may be returned while excluding less relevant results.

In an alternative example, the user may have accounts at both of the search engine service and the brick and mortar store that are linked. Thus, embodiments may provide results 114 for brick and mortar stores with which the user at the client device 202 has accounts.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

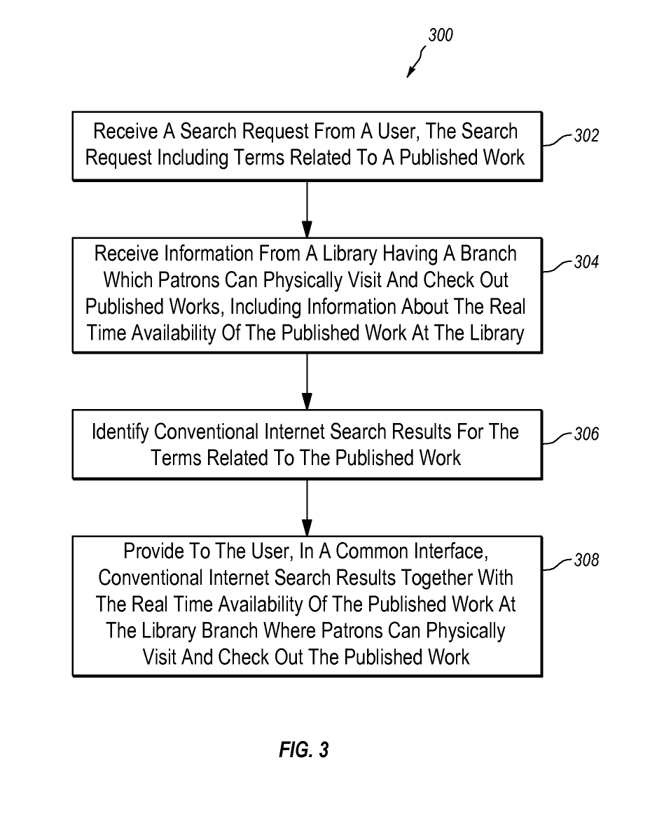

Referring now to FIG. 3, a method 300 is illustrated. The method 300 includes acts for providing real time information on the availability of physical published works at a library available for check-out by patrons of the library. The method 300 includes, at a search engine service, receiving a search request from a user (act 302). The search request includes terms related to a published work. For example, as illustrated in FIG. 1A, a user may enter search terms into a text input box 102 and press the search button 104, causing the entered terms to be sent to, and received by a search engine service 206.

The method 300 further includes receiving information from a library having a branch which patrons can physically visit and check out published works, including information about the real time availability of the published work at the library (act 304). For example, as illustrated in FIG. 2, the search engine service 206 can receive information about works at the library 210, an in particular from the ILS 208. In some embodiments, the real time availability may include an indication of at least one of that the published work is checked-in at the library branch, checked-out at the library branch, or on hold at the library branch.

The method 300 further includes identifying conventional Internet search results for the terms related to the published work (act 306). For example, the search engine service 206 may have indexed results that can be provided based on search terms provided to the search engine service 206.

The method 300 further includes providing to the user, in a common interface, conventional Internet search results together with the real time availability of the published work at the library branch where patrons can physically visit and check out the published work (act 308). FIGS. 1A-1F illustrates examples of this functionality.

As noted above, the method 300 may be practiced where receiving information from a library having a branch which patrons can physically visit and check out published works includes receiving information from an integrated library system (ILS) for the branch. For example, as illustrated in FIG. 2, an ILS 208 may provide information about works at the library 210. In some embodiments, this may be accomplished by the search engine service 206 sending a request to the ILS 208 including the terms related to a published work, after which receiving information from a library is performed. In an alternative embodiment, one or more published works are identified based on the terms in the search request. A request is then sent to the ILS including identification of the published works. The ILS returns results to the search engine service 206. In some embodiments, this may be accomplished where specifically identifying one or more published works includes identifying one or more published works from the conventional Internet search results for the terms related to the published work.

The method 300 may further include identifying a brick and mortar store proximate the user where the published work can be obtained and identifying a number of copies available at the brick and mortar store. For example, as illustrated in FIG. 2, the brick and mortar store 214 may return (via the inventory server 212) information to the search engine service 206 about published works available from the brick and mortar store. This information can then be provided to the user as the client device 202.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of providing real time information on the availability of physical published works at a library available for check-out by patrons of the library, the method comprising:
at a search engine service, receiving a search request from a user, the search request including terms related to a published work;
receiving information from a library having a branch which patrons can physically visit and check out published works, including information about the real time availability of the published work at the library;
identifying conventional Internet search results for the terms related to the published work;
providing to the user, in a common interface, conventional Internet search results together with the real time availability of the published work at the library branch where patrons can physically visit and check out the published work.

2. The method of claim 1, wherein receiving information from a library having a branch which patrons can physically visit and check out published works, including information about the real time availability of the published work at the library comprises receiving information from an integrated library system (ILS) for the branch.

3. The method of claim 2, further comprising sending a request to the ILS including the terms related to a published work, after which receiving information from a library is performed.

4. The method of claim 2, further comprising:
based on the terms in the search request, specifically identifying one or more published works; and
sending a request to the ILS including identification of the published works, after which receiving information from a library is performed.

5. The method of claim 4, wherein specifically identifying one or more published works comprises identifying one or more published works from the conventional Internet search results for the terms related to the published work.

6. The method of claim 1, further comprising identifying a brick and mortar store proximate the user where the published work can be obtained and identifying a number of copies available at the brick and mortar store.

7. The method of claim 1, wherein the real time availability includes an indication of at least one of that the published work is checked-in at the library branch, checked-out at the library branch, or on hold at the library branch.

8. A computer readable storage medium comprising computer executable instructions that when executed by one or more processors cause the following to be performed:
at a search engine service, receiving a search request from a user, the search request including terms related to a published work;
receiving information from a library having a branch which patrons can physically visit and check out published works, including information about the real time availability of the published work at the library;
identifying conventional Internet search results for the terms related to the published work;
providing to the user, in a common interface, conventional Internet search results together with the real time availability of the published work at the library branch where patrons can physically visit and check out the published work.

9. The computer readable medium of claim 8, wherein receiving information from a library having a branch which patrons can physically visit and check out published works, including information about the real time availability of the published work at the library comprises receiving information from an integrated library system (ILS) for the branch.

10. The computer readable medium of claim 9, further comprising computer executable instructions that when executed by one or more processors cause the following to be performed:
sending a request to the ILS including the terms related to a published work, after which receiving information from a library is performed.

11. The computer readable medium of claim 9, further comprising computer executable instructions that when executed by one or more processors cause the following to be performed:
based on the terms in the search request, specifically identifying one or more published works; and
sending a request to the ILS including identification of the published works, after which receiving information from a library is performed.

12. The computer readable medium of claim 11, wherein specifically identifying one or more published works comprises identifying one or more published works from the conventional Internet search results for the terms related to the published work.

13. The computer readable medium of claim 8, further comprising computer executable instructions that when executed by one or more processors cause the following to be performed:
identifying a brick and mortar store proximate the user where the published work can be obtained and identifying a number of copies available at the brick and mortar store.

14. The computer readable medium of claim 8, wherein the real time availability includes an indication of at least one of that the published work is checked-in at the library branch, checked-out at the library branch, or on hold at the library branch.

15. A computing system for providing real time information on the availability of physical published works at a library available for check-out by patrons of the library, the system comprising:
one or more processors; and
one or more computer readable media, wherein the one or more computer readable media comprise computer executable instructions that when executed by at least one of the one or more processors cause the system to perform the following:
at a search engine service, receiving a search request from a user, the search request including terms related to a published work;
receiving information from a library having a branch which patrons can physically visit and check out published works, including information about the real time availability of the published work at the library;
identifying conventional Internet search results for the terms related to the published work;
providing to the user, in a common interface, conventional Internet search results together with the real time availability of the published work at the library branch where patrons can physically visit and check out the published work.

16. The system of claim 15, wherein receiving information from a library having a branch which patrons can physically visit and check out published works, including information about the real time availability of the published work at the library comprises receiving information from an integrated library system (ILS) for the branch.

17. The system of claim 16, the computer readable media further comprising computer executable instructions that when executed by one or more processors cause the following to be performed:
sending a request to the ILS including the terms related to a published work, after which receiving information from a library is performed.

18. The system of claim 16, the computer readable media further comprising computer executable instructions that when executed by one or more processors cause the following to be performed:
based on the terms in the search request, specifically identifying one or more published works; and
sending a request to the ILS including identification of the published works, after which receiving information from a library is performed.

19. The system of claim 18, wherein specifically identifying one or more published works comprises identifying one or more published works from the conventional Internet search results for the terms related to the published work.

20. The system of claim 15, wherein the real time availability includes an indication of at least one of that the published work is checked-in at the library branch, checked-out at the library branch, or on hold at the library branch.
